(19) United States
(12) Patent Application Publication
(10) Pub. No.: US 2019/0239692 A1
(43) Pub. Date: Aug. 8, 2019

(54) COFFEE GRINDER AND SLEEVE

(71) Applicant: BLACK RIFLE COFFEE COMPANY LLC, Salt Lake City, UT (US)

(72) Inventors: Evan Hafer, Salt Lake City, UT (US); Jeffrey B. Kirkham, Draper, UT (US); Haase Robert Andreas, Kamas, UT (US)

(21) Appl. No.: 16/263,658

(22) Filed: Jan. 31, 2019

Related U.S. Application Data
(60) Provisional application No. 62/625,723, filed on Feb. 2, 2018.

(51) Int. Cl. A47J 42/16; B24B 5/35; A47J 43/044

(52) U.S. Cl. CPC A47J 42/16; A47J 43/044; B24B 5/35

(57) ABSTRACT

A grinding unit is provided, which includes an elongated body, a top cap, a bottom cap, a grinding lever, and a supporting sleeve. The supporting sleeve surrounds the elongated body and includes a support channel. The support channel is structured so that the grinding lever can be removably affixed to the support channel with a friction fit.

### CROSS-REFERENCE TO RELATED APPLICATIONS

This application claims priority to U.S. Provisional Application Ser. No. 62/625,723, filed on Feb. 2, 2018 and entitled “COFFEE GRINDER AND SLEEVE,” the entirety of which is incorporated herein by reference.

### BACKGROUND

In today's world, many people drink coffee. People drink coffee in all kinds of different environments, ranging from luxurious environments to rugged environments.

In order to make coffee, a coffee bean must first be grounded into smaller particles. Different types of grinding methods are available depending on the type of coffee that is to be brewed. For example, the beans can be ground in a coarse, medium, or fine manner. The way that coffee beans are ground plays a dramatic impact on how the coffee tastes. As a result, many different types of coffee grinders have been developed. However, there is an ongoing need for improvements in coffee grinder technologies. For instance, some grinders are not easy to hold. Other grinders have crank levers/handles that become loosened and can make the grinders difficult to pack in a compact way. Accordingly, there is an ongoing need to provide improvements in coffee grinders, particularly small hand-held coffee grinders with crank levers, that make them easier to use and to pack in a compact way.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Disclosed embodiments include a grinding unit. In some embodiments, a grinding unit includes an elongated body, a top cap, a bottom cap, a grinding lever, and a supporting sleeve. The supporting sleeve surrounds the elongated body and includes a support channel. The support channel is structured so that the grinding lever can be removably affixed to the support channel with a friction fit.

Some disclosed embodiments include methods for assembling a grinding unit. In some embodiments, the method includes an act of affixing a top cap of the grinding unit to an elongated body of the grinding unit, and further affixing a bottom cap of the grinding unit to the elongated body of the grinding unit. The method further includes sliding a supporting sleeve onto the elongated body such that the supporting sleeve surrounds the elongated body. The supporting sleeve includes a support channel, and the support channel is structured so that a grinding lever can be removably affixed to the support channel with a friction fit. Finally, the method includes affixing the grinding lever within the support channel with a friction fit.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates an example coffee grinder.

FIG. 2 illustrates a side profile view of the coffee grinder.

FIG. 3 illustrates a top inclined view of the coffee grinder.

FIGS. 4-5 illustrate top aerial views of the coffee grinder.

FIG. 6 illustrates an exploded view of the coffee grinder.

FIG. 7 illustrates a bottom view of the coffee grinder.

FIG. 8 illustrates a top view of the coffee grinder.

FIG. 9 illustrates a close-up view of a supporting sleeve.

FIGS. 10-11 illustrate various views of a grinding lever.

FIG. 12 illustrates how the grinding lever may be affixed to the top cap of the coffee grinder.

FIGS. 13-16 illustrate various other perspective views of how the grinding lever may be affixed to the top cap of the coffee grinder.

FIGS. 17-18 illustrate other bottom views of the coffee grinder.

FIGS. 19-20 illustrate that the supporting sleeve may be removed from the coffee grinder.

FIG. 21 illustrates a flowchart of an example method for assembling a coffee grinder.

### DETAILED DESCRIPTION

Disclosed embodiments are directed to a coffee grinder that includes a robust supporting sleeve. Together, these two components enable the coffee grinder to be reduced to a compactable, highly portable unit. In particular, the coffee grinder includes a grinding mechanism encased within a central, elongated body. Affixed to a top portion of this elongated body is a top cap. Affixed to the bottom portion of the elongated body is a bottom cap. When combined, the top cap, the elongated body, and the bottom cap form a cylindrical unit that can, in some instances, have the appearance of a shotgun shell, a handgun round, or a rifle round. In other words, the cylindrical unit can take the appearance of any type of ammunition, thereby improving the aesthetics of the coffee grinder for some environments.

In some embodiments, the coffee grinder is configured with a rugged and textural gripping/protective sleeve. In some instances, this supporting sleeve is structured to be removable from the coffee grinder. Furthermore, the supporting sleeve includes a support channel for holding a grinding crank lever of the coffee grinder. Accordingly, the disclosed embodiments are directed to a highly compact, highly portable coffee grinder and supporting sleeve unit.

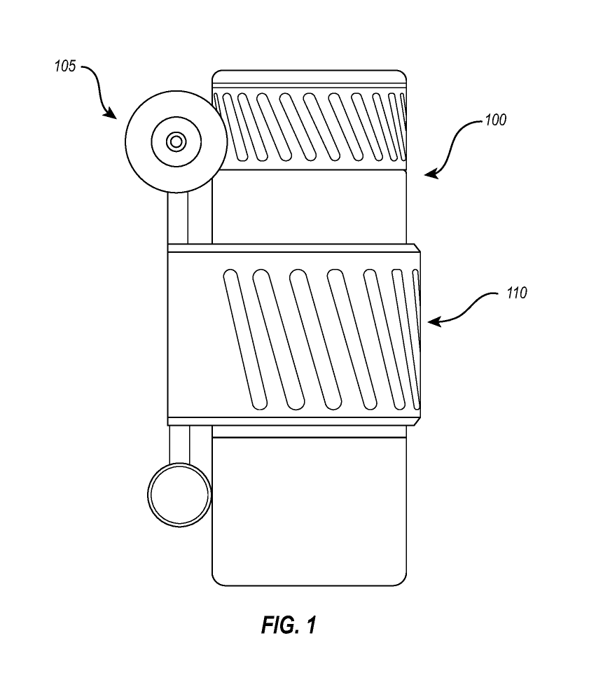

Attention will now be directed to FIG. 1. Here, a coffee grinder 100 is presented. This coffee grinder 100 includes a grinding lever 105 and a supporting sleeve 110. In the scenario presented in FIG. 1, the supporting sleeve 110 is structured to include a support channel (not shown in FIG. 1, but it will be discussed in detail with respect to later figures). The support channel is structured in such a manner so that the grinding lever 105 may be positioned within the support channel. As a result, the grinding lever 105 can be affixed to the grinder 100 via the supporting sleeve 110. Accordingly, the coffee grinder 100 can be transported without fear of the grinding lever 105 being lost or separated from the coffee grinder 100.

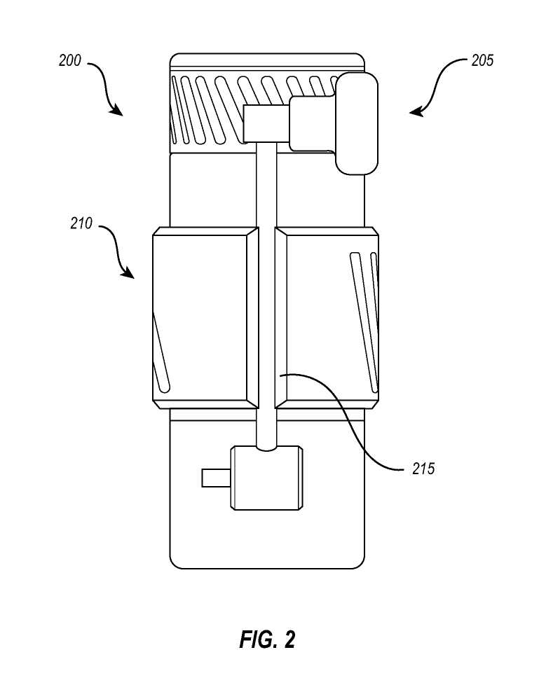

FIG. 2 shows a different perspective view of a coffee grinder 200. The coffee grinder 200 is representative of coffee grinder 100 of FIG. 1. Similar to FIG. 1, coffee grinder 200 includes a grinding lever 205 and a supporting sleeve 210. As shown in FIG. 2, supporting sleeve 210 includes a support channel 215 which is structured in size and shape so that grinding lever 205 may be placed therein with a friction fit. As a result, support channel 215 enables grinding lever 205 to be physically attached to the supporting sleeve 210 and removably held in place with a friction fit.

Other than a friction fit, it will be appreciated that the support channel 215 of the supporting sleeve 210 is configurable to secure the grinding lever 205 in various ways. For example, in some embodiments, the supporting sleeve 210 includes a magnetic element and the grinding lever 205 includes a corresponding magnetic element, such that the magnetic elements can be used to secure the grinding lever 205 to the supporting sleeve 210. In other embodiments, the grinding lever 205 is attachable to the supporting sleeve 210 with a hook and loop connection, a belt, a strap, a latch and clasp, or any other type of connecting device. In yet other embodiments, the supporting sleeve 210 includes a support channel (e.g., support channel 215) with a stop at one end and an adjustable stop at the other end, and the grinding lever 205 includes an elongated element which is configured to slide into the support channel and be held in place by the stop and the adjustable stop.

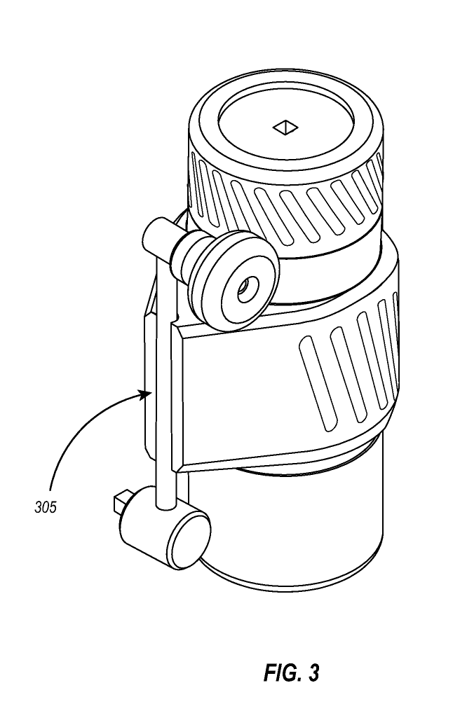

FIG. 3 shows another view of a support channel 305. Here, this support channel 305 is representative of the support channel 215 of FIG. 2. It will be appreciated that the supporting sleeve (e.g., the supporting sleeve 210 of FIG. 2) is comprised of a flexible material that allows the grinding lever to be partially enveloped within the material (to be discussed in further detail later). For example, the supporting sleeve 210 can be made of plastic, rubber, silicone, neoprene, or any other type of flexible material. Such flexible/resilient materials provide protection to the coffee grinder (in the case of impact) and also increase the tactile/textural grip of the grinder to facilitate a user holding the grinder during use (without it slipping in their hand during the grinding). The irregular shape of the supporting sleeve, due to the support channel 305, also increases the ability of a user to grip and hold the grinder (without slipping) during use. Texturing formed on the sleeve (e.g., sleeve 210 from FIG. 2) can aesthetically mimic rifling or other desired aesthetics. The texturing is not just an aesthetic or design choice because it can also be used to improve a user's ability to grip the sleeve. In this regard, the texturing can include any combination of indents, protrusions, lining, channeling, bumps, or any other type of grippable texturing.

The wall thickness of the supporting sleeve (e.g., sleeve 210 from FIG. 2) may vary to accommodate different needs and preferences, from a single millimeter to several millimeters. Likewise, the support channel 305 can have different radii of curvature, to accommodate different needs and preferences (such as desired friction fitting) and to accommodate different sized levers, from less than a millimeter to several millimeters.

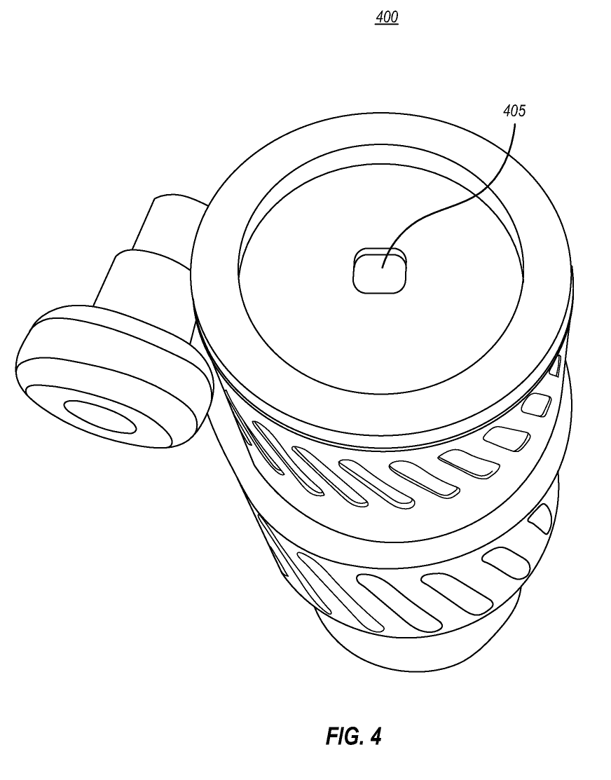

FIG. 4 show's a top perspective view of the coffee grinder 400. As can be seen in FIG. 4, the grinding lever is attached to the coffee grinder via the supporting sleeve. Additionally, FIG. 4 shows that the top portion of the coffee grinder includes a crank hole 405. When a portion of the grinding lever is situated within this crank hole 405, then the coffee grinder 400 can be used to grind coffee by rotating the grinding lever about the central portion of the coffee grinder 400.

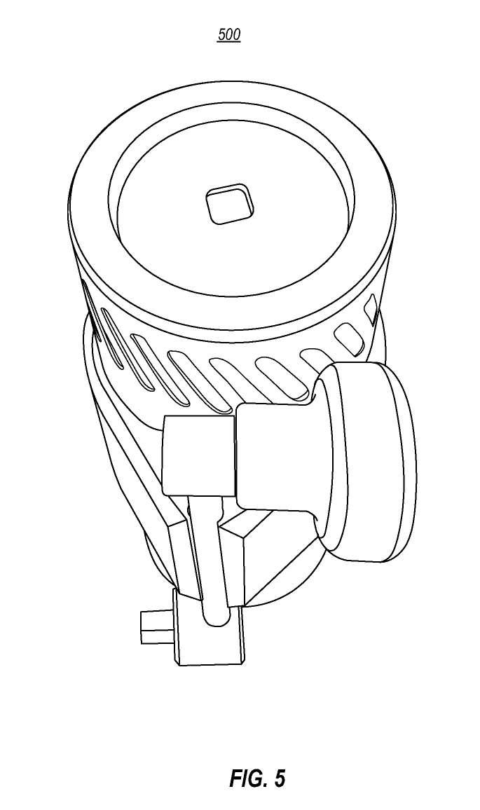

FIG. 5 shows another top perspective view 500 of the coffee grinder. In particular, FIG. 5 shows how the grinding lever may be physically attached to the coffee grinder via the supporting sleeve, or, alternatively, within the crank hole.

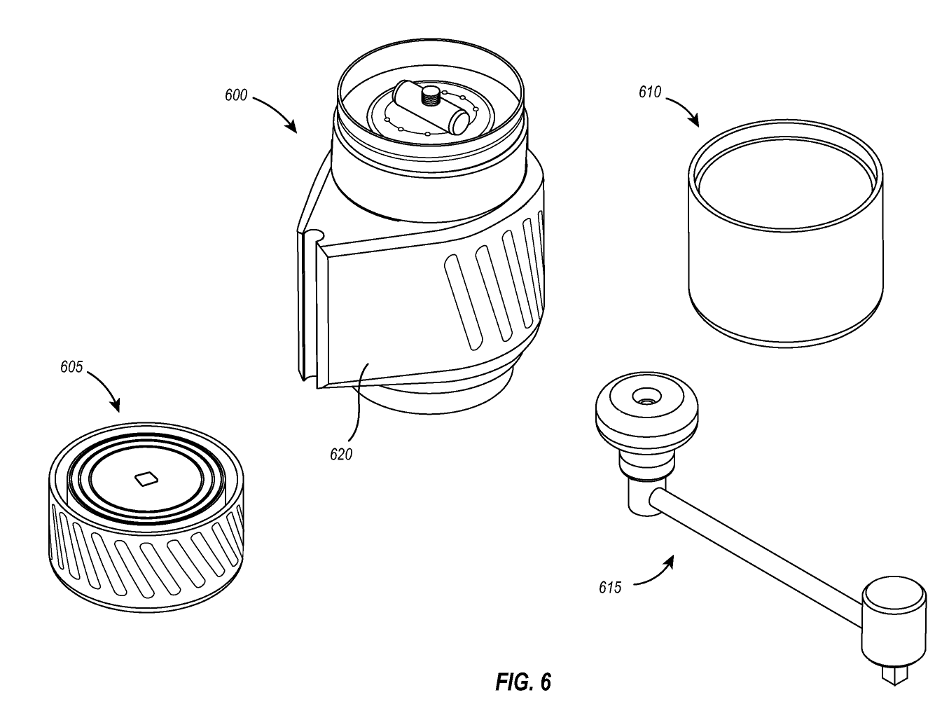

Turning now to FIG. 6, FIG. 6 shows a situation in which a coffee grinder 600 has been disassembled into some of its various parts (i.e. an exploded view). Here, coffee grinder 600 includes a top cap 605, a bottom cap 610, a grinding lever 615, and a supporting sleeve 620. When the top cap 605 is removed, coffee beans can be placed within a resulting cavity that is exposed. When the top cap 605 is placed back on the coffee grinder 600 and a portion of the grinding lever 615 is affixed to the top cap 605 (via the crank hole in the top cap 605), then the coffee beans can be ground by rotating the grinding lever 615 about the coffee grinder 600. With the bottom cap 610 removed, the ground coffee beans are able to exit the coffee grinder 600 and can be used to make coffee. As can be seen from FIG. 6, the grinding lever 615 can be attached to or detached from the supporting sleeve 620. When the grinding lever 615 is attached to the supporting sleeve 620, the coffee grinder 600 is preserved in a highly compact state. When the grinding lever 615 is removed from the supporting sleeve 620 and is affixed to the top cap 605, then the coffee grinder 600 may be used to grind coffee beans.

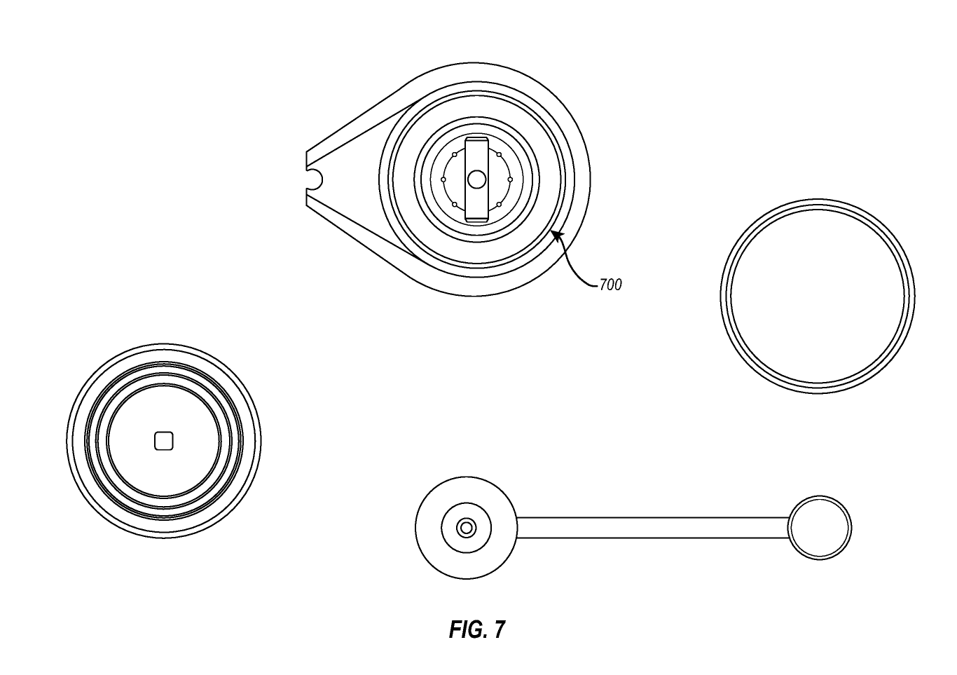

FIG. 7 shows another perspective of the exploded view of the coffee grinder. Here, the bottom 700 of the coffee grinder is exposed to view. From this bottom 700, grounded particles (e.g., grounded coffee beans) can exit the coffee grinder.

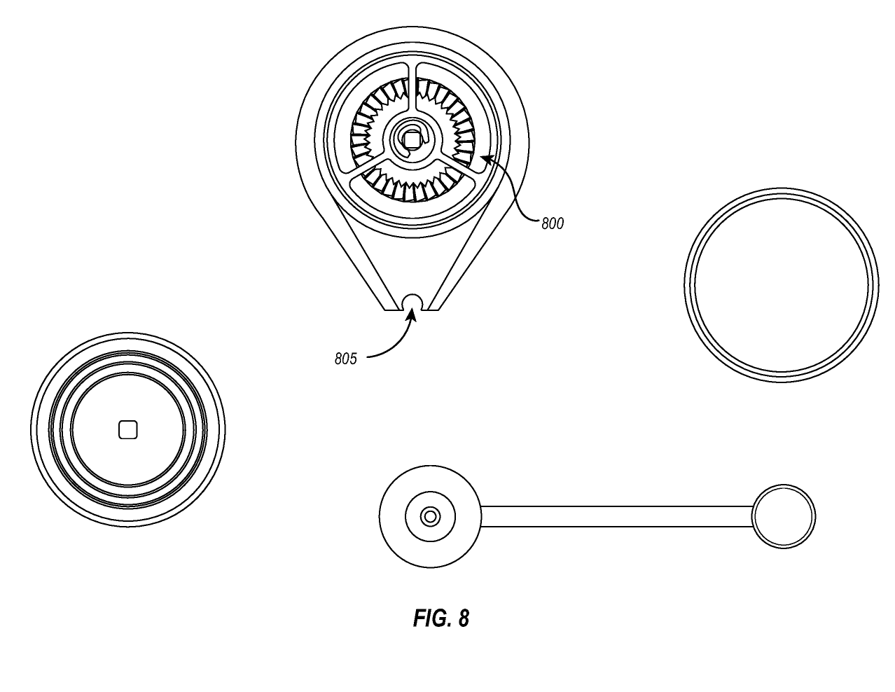

FIG. 8 show's yet another perspective of the exploded view of the coffee grinder. Here, the top 800 of the coffee grinder is exposed to view. As can be seen in FIG. 8, when the top cap is removed, a cavity is exposed. Coffee beans (or any other material) may be placed within this cavity. When the top cap is placed back on the coffee grinder and a portion of the grinding lever is attached thereto (i.e. a portion of the grinding lever is inserted into the top cap's crank hole), then the coffee beans in the cavity can be grounded into fine particles. Accordingly, FIG. 8 shows a top aerial view of the top portion of the coffee grinder.

FIG. 8 also shows another perspective of the support channel 805, which is representative of the supporting channel 305 of FIG. 3. As illustrated, the support channel 805 is formed as a part of the supporting sleeve. Further, the shape and dimensions of the support channel 805 are structured so as to allow the grinding lever to fit therein. When the grinding lever is disposed within the support channel 805, then the unit, as whole (i.e. the coffee grinder and the grinding lever), is highly compact and portable.

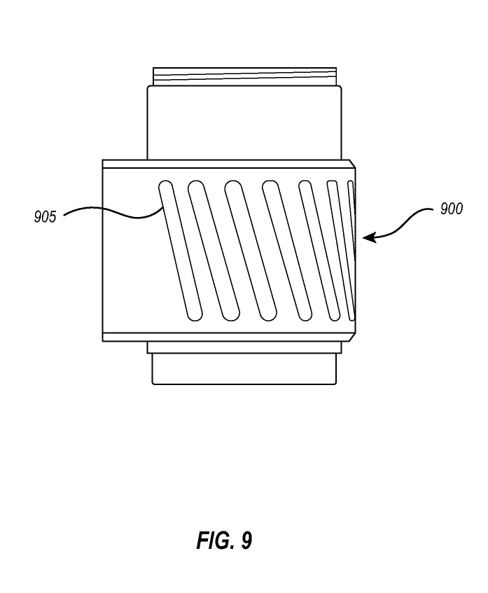

FIG. 9 shows a close-up view of the supporting sleeve 900. Here, it will be appreciated that the supporting sleeve 900 is able to slide on and off of the coffee grinder (further detail on this feature will be presented later). In some embodiments, the supporting sleeve 900 includes elongated grooves 905. These elongated grooves 905 are beneficial for a variety of reasons. For example, the elongated grooves 905 provide additional grip support when the grinder is in use. Additionally, the elongated grooves 905 help prevent the grinder from rolling when it is placed on its side.

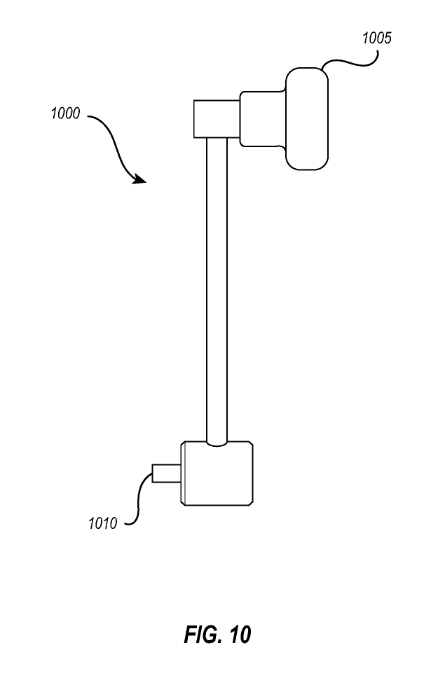

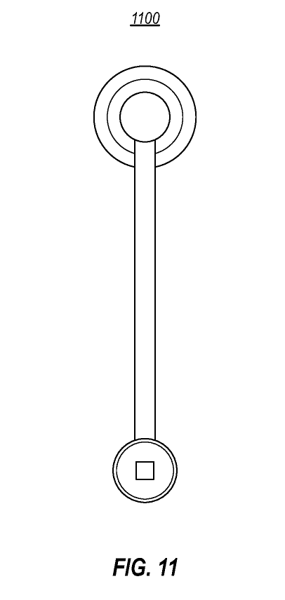

Turning now to FIGS. 10 and 11, these Figures illustrate various views of the grinding lever. As can be seen in FIG. 10, the grinding lever 1000 includes a handle portion 1005 for gripping the grinding lever 1000 when in use. Additionally, the grinding lever 1000 includes a portion 1010 that is structured to fit within a corresponding cavity (i.e. a crank hole) in the top cap of the grinder. When the portion 1010 is disposed within the top cap's corresponding cavity (i.e. the crank hole), then the grinding lever 1000 can be used to grind materials that have been placed within the coffee grinder. FIG. 11 illustrates another view 1100 of the grinding lever.

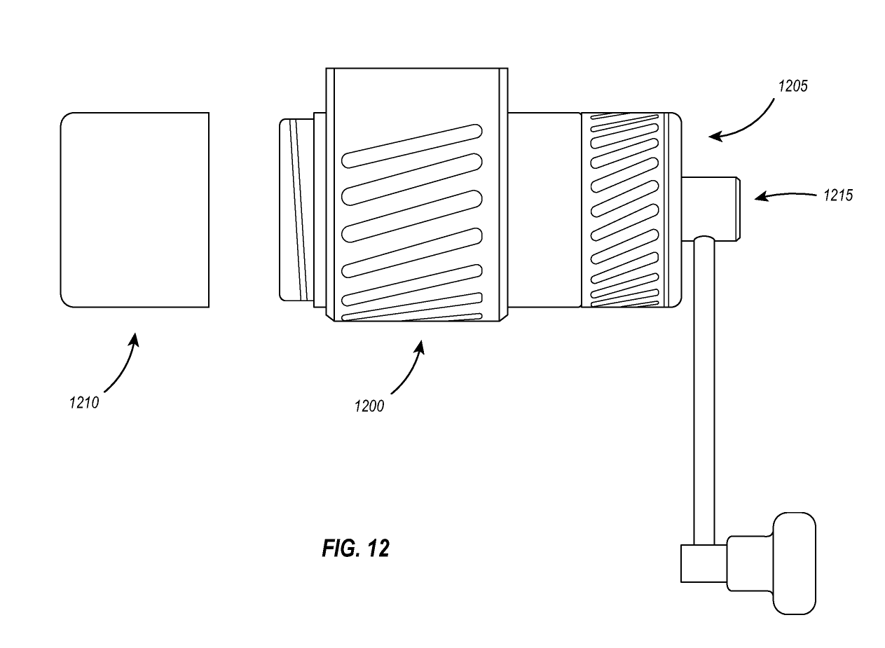

FIG. 12 shows how the grinding lever may be affixed to the top cap of the coffee grinder. Here, the coffee grinder 1200 includes a top cap 1205 and a bottom cap 1210. As discussed earlier, when the bottom cap 1210 is removed from the coffee grinder 1200, then fine-grained particles are able to exit the coffee grinder 1200 after being grounded. In the scenario presented in FIG. 12, a portion 1215 (currently not visible as a result of it being inserted into a cavity) of the grinding lever has been inserted into or otherwise connected to a corresponding cavity (i.e. a crank hole) of the top cap 1205. The portion 1215 is representative of the portion 1010 of FIG. 10. When thusly situated, the grinding lever enables a user to rotate the top cap 1205. When coffee beans are inserted into the coffee grinder 1200 and the top cap 1205 is rotated using the grinding lever, then the coffee beans can be ground into fine particles. In this regard, when the level is rotated, so too is the top cap 1205 in order to grind the beans.

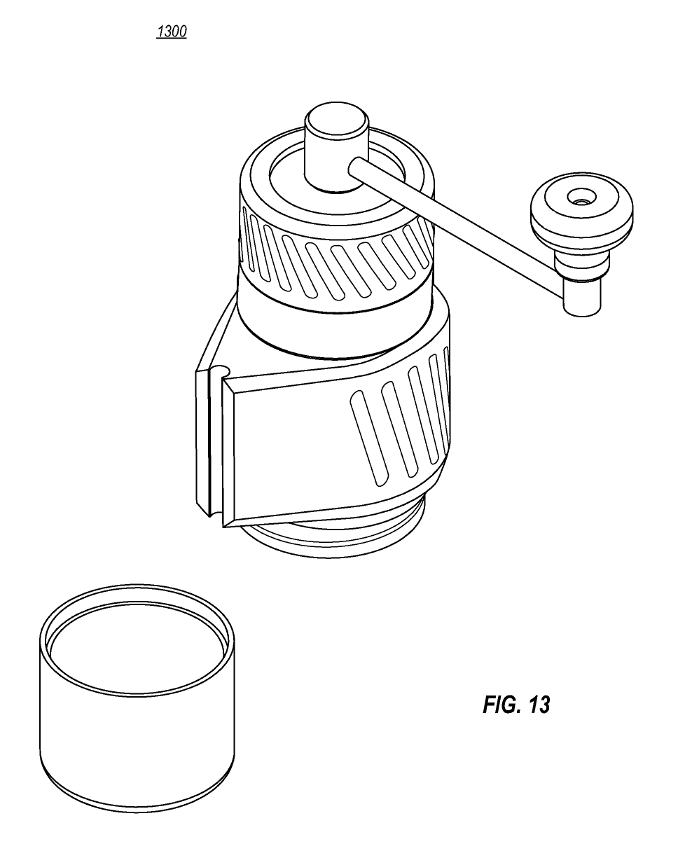

FIG. 13 provides another perspective view 1300 of how the grinding lever may be affixed to the top cap. FIG. 13 also shows another perspective of the support channel that is located on the supporting sleeve.

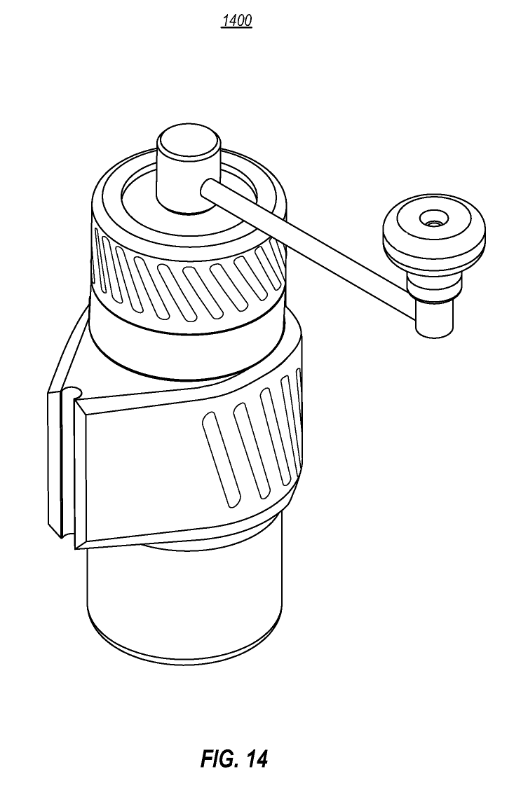

FIG. 14 shows yet another perspective view 1400 of how the grinding lever may be affixed to the top cap. In this situation, however, the bottom cap is shown as being mounted to the coffee grinder.

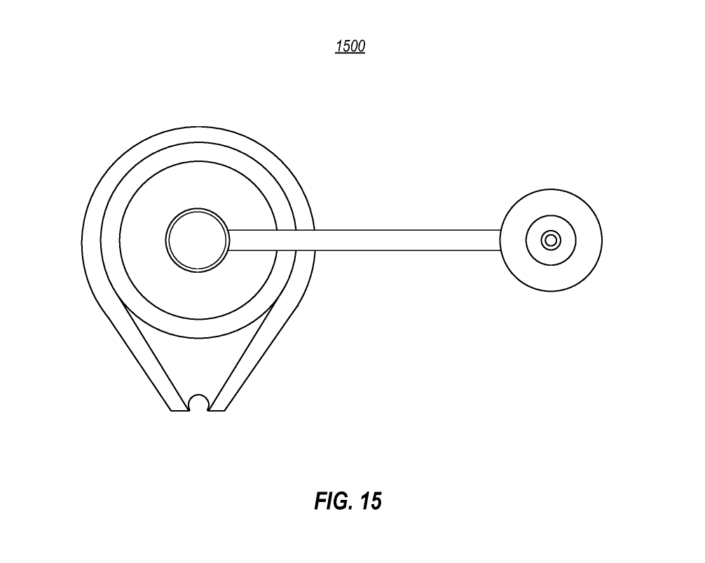

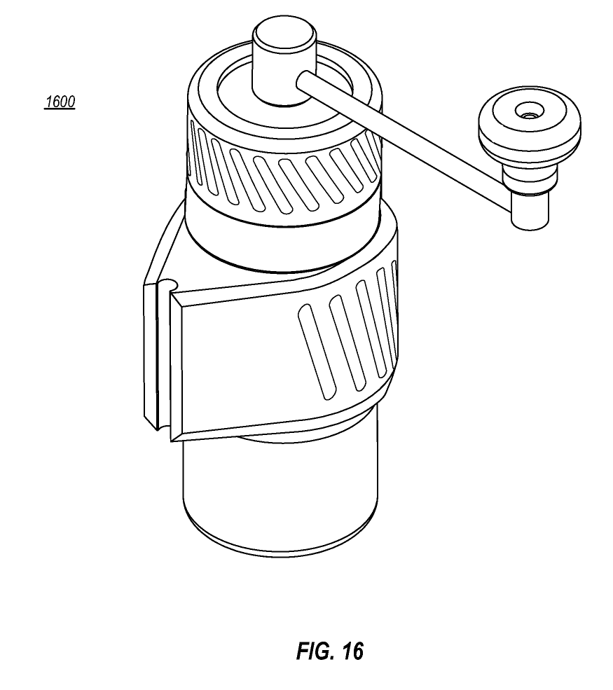

FIG. 15 shows a top aerial view 1500 of the grinding lever and the coffee grinder. Additionally, FIG. 15 shows the support channel on the supporting sleeve. FIG. 16 shows a top angled view 1600 of the coffee grinder.

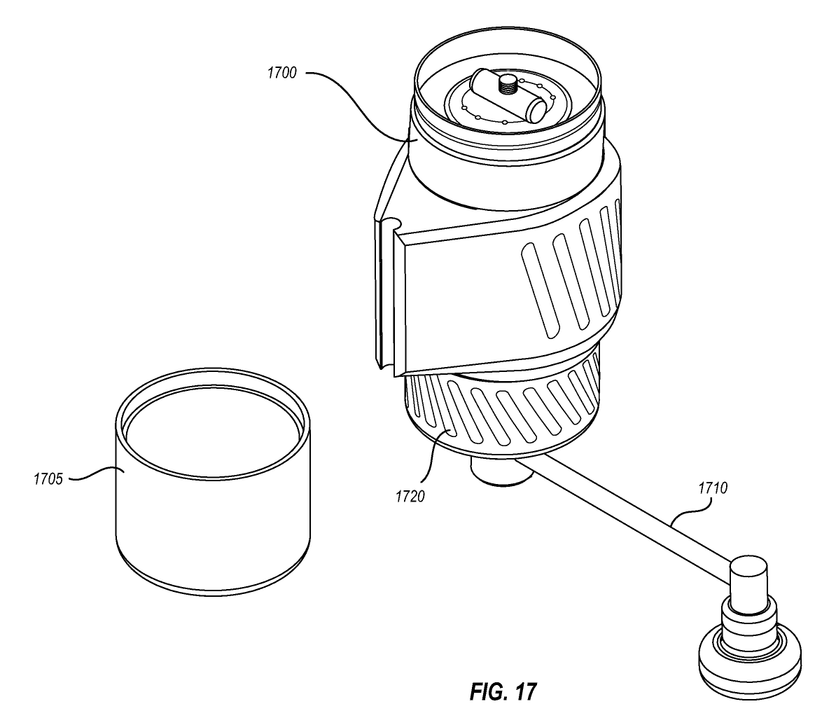

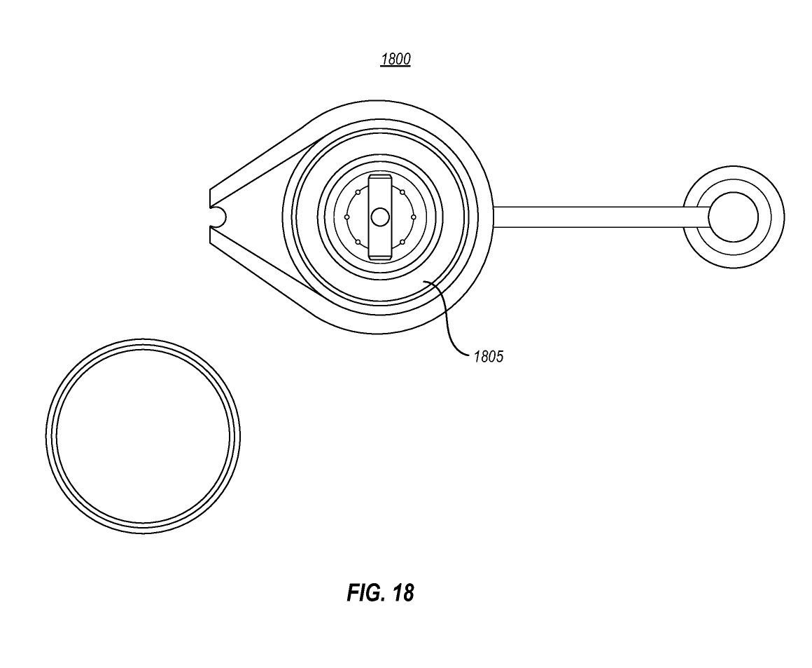

FIG. 17 shows the coffee grinder 1700 with the bottom cap 1705 removed and the grinding lever 1710 affixed to the top cap 1720. Relatedly, FIG. 18 shows another perspective view 1800 of the bottom portion 1805 of the coffee grinder.

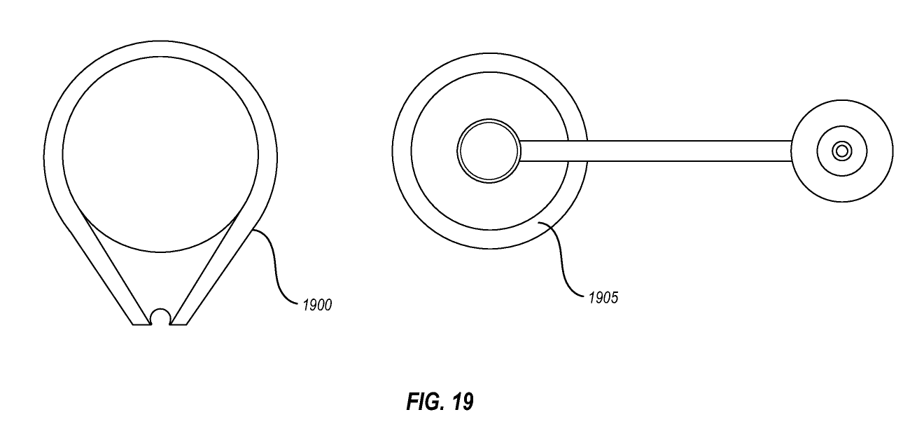

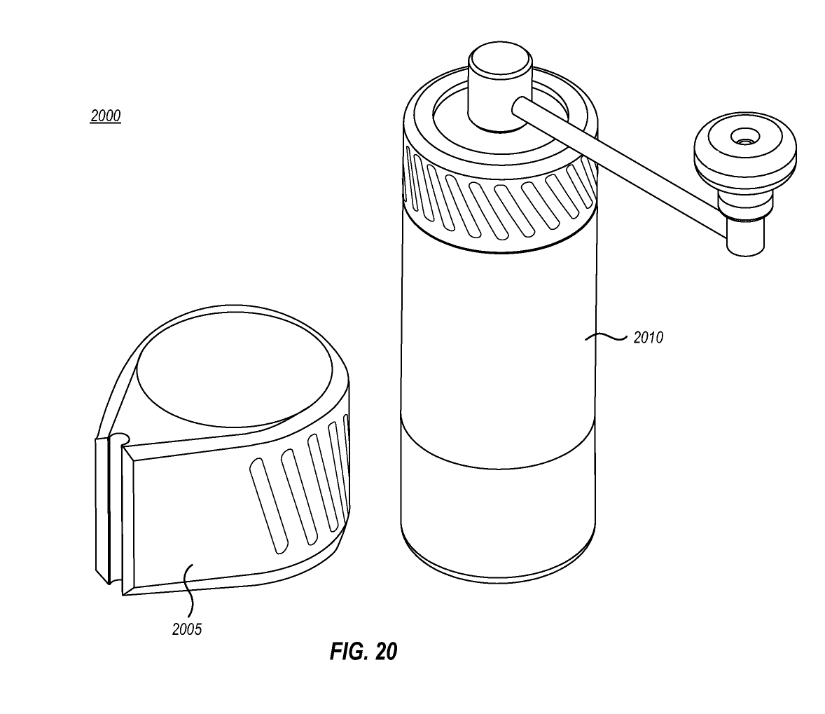

Attention will now be directed to FIG. 19. Here, the supporting sleeve 1900 has been removed from the coffee grinder 1905. Relatedly, FIG. 20 shows another perspective view 2000 of the supporting sleeve 2005 after it has been removed from the coffee grinder 2010. Accordingly, it will be appreciated that in some embodiments, the supporting sleeve 2005 may be detached from the coffee grinder 2010.

It will be noted, with regard to the sleeve, that the sleeve comprises a supporting sleeve for a coffee grinder that is removably attachable to the coffee grinder and which is particularly beneficial when the coffee grinder includes a detachable grinding lever. In these embodiments, the sleeve body is structured in size and shape to surround a portion or entirety of the coffee grinder via friction fit such that the sleeve body is removably affixable to the coffee grinder with a friction fit. The sleeve also includes a support channel that is structured to receive and removably secure the detachable grinding lever of the coffee grinder within the support channel with a friction fit and such that the grinding lever is detachably securable and removable from the support channel of the supporting sleeve.

Up to this point, the disclosure has focused on embodiments where the grinding lever is detachable from the coffee grinder. It will be appreciated, however, that some embodiments are structured so that the grinding lever is physically mounted and not removable from the coffee grinder. For instance, in these embodiments, the grinding lever is mounted to the coffee grinder via a hinge that allows the grinding lever to move from a position that is approximately parallel to the main cylindrical body of the coffee grinder to a position that is approximately perpendicular to the main cylindrical body. Additionally, it will be appreciated that when the grinding lever is positioned in parallel to the main cylindrical body, then the grinding lever may be disposed within the support channel of the supporting sleeve. While in the position, any movements of the grinding lever are restricted.

The disclosed embodiments may, in some instances, provide various advantages over conventional grinding units. Some of these advantages include providing users with a coffee grinder with components which enable the coffee grinder to be reduced to a compactable, highly portable unit.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

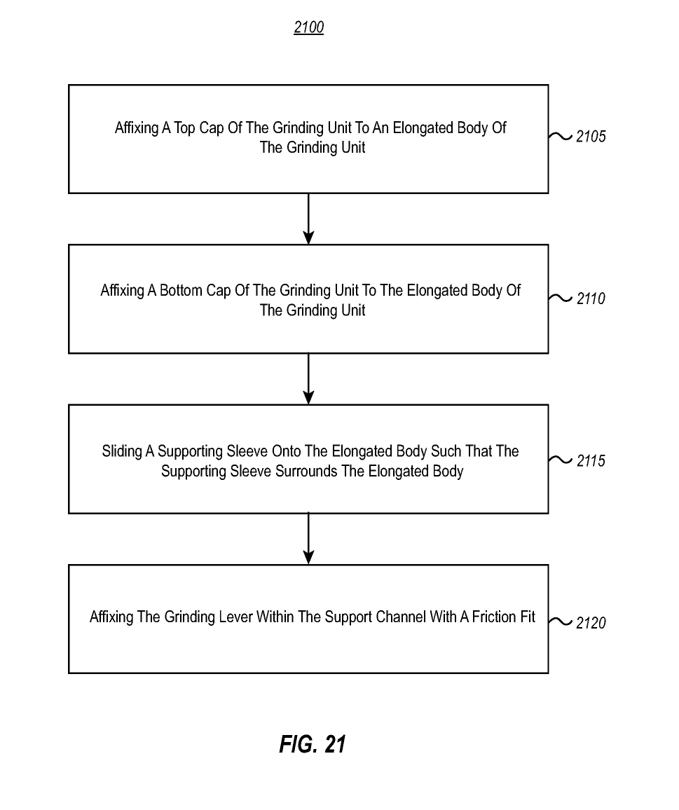

In particular. FIG. 21 show's a flowchart of an example method 2100 for assembling a grinding unit (e.g., a coffee grinder as shown and described in relation to FIGS. 1-20). Method 2100 includes an act 2105 of affixing a top cap of the grinding unit to an elongated body of the grinding unit. The top cap of the grinding unit, in some embodiments, corresponds to the top cap 605 described hereinabove and includes a crank hole to which a grinding lever is affixable. When the grinding lever is affixed to the top cap via the crank hole, coffee beans, or other materials placed within the grinding unit, can be ground by rotating the grinding lever.

Method 2100 further includes an act 2110 of affixing a bottom cap of the grinding unit to the elongated body of the grinding unit. In some embodiments, the bottom cap corresponds to the bottom cap 610 described above with reference to FIG. 6. The bottom cap, in some instances, may be removed for ground coffee beans (or other material) to exit the coffee grinder.

Furthermore, method 2100 includes an act 2115 of sliding a supporting sleeve onto the elongated body of the grinding unit such that the supporting sleeve surrounds the elongated body. In some embodiments, the supporting sleeve includes a support channel which is structured so that a grinding lever can be removably affixed to the support channel with a friction fit. In some embodiments, the supporting sleeve corresponds to the supporting sleeve 210 as described hereinabove.

Finally, method 2100 includes an act 2120 of affixing the grinding lever within the support channel with a friction fit. When the grinding lever is thus situated, in some implementations, the grinding unit is reduced to a compactable, highly portable unit

Accordingly, it will be appreciated that the disclosed embodiments are directed to a grinding unit that includes a top cap, a bottom cap, and an elongated body. Additionally, the grinding unit includes a grinding lever and a supporting sleeve. This supporting sleeve includes a support channel. Here, the support channel is structured to be able to accommodate the grinding lever. In other words, the dimensions of the support channel are such that the support channel is able to partially envelope the grinding lever. In this manner, the grinding lever may be affixed to the coffee grinder in a highly portable fashion.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A grinding unit comprising:
an elongated body;
a top cap;
a bottom cap;
a grinding lever; and
a supporting sleeve, the supporting sleeve surrounding the elongated body and including a support channel, the support channel being structured so that the grinding lever can be removably affixed therein with a friction fit.

2. The grinding unit of claim 1, wherein the top cap, the elongated body, and the bottom cap are combinable to form a cylindrical unit.

3. The grinding unit of claim 1, wherein the supporting sleeve includes a plurality of indents or protrusions along an exterior of the supporting sleeve.

4. The grinding unit of claim 1, wherein the top cap includes a crank hole configured for receiving a portion of the grinding lever that is structured to fit within the crank hole.

5. The grinding unit of claim 1, wherein the supporting sleeve is slidable along an exterior of the elongated body and wherein the supporting sleeve is removable from the elongated body.

6. A method for assembling a grinding unit, the method comprising:
affixing a top cap of the grinding unit to an elongated body of the grinding unit;
affixing a bottom cap of the grinding unit to the elongated body of the grinding unit;
sliding a supporting sleeve onto the elongated body such that the supporting sleeve surrounds the elongated body, wherein the supporting sleeve includes a support channel, the support channel being structured so that a grinding lever can be removably affixed to the support channel with a friction fit; and
affixing the grinding lever within the support channel with a friction fit or, alternatively, affixing the grinding lever within a crank hole of the top cap.

7. The method of claim 1, wherein the top cap, the elongated body, and the bottom cap, when affixed to one another, form a cylindrical unit.

8. The method of claim 1, wherein the supporting sleeve includes a plurality of indents or protrusions along an exterior of the supporting sleeve.

9. The method of claim 1, wherein the crank hole is structure for receiving a portion of the grinding lever that is structured to fit within the crank hole.

10. The method of claim 9, further comprising:
removing the grinding lever from the support channel; and
positioning the portion of the grinding lever that is structured to fit within the crank hole of the top cap within the crank hole of the top cap.

11. A supporting sleeve that is removably attachable to a coffee grinder that includes a detachable grinding lever, the supporting sleeve including:
a sleeve body structured to surround the coffee grinder via friction fit such that the sleeve body is removably affixable to the coffee grinder with a friction fit; and
a support channel structured to receive and removably secure the detachable grinding lever of the coffee grinder within the support channel with a friction fit and such that the grinding lever is detachably securable and removable from the support channel of the supporting sleeve.
